(19) United States
(12) Patent Application Publication
(10) Pub. No.: US 2020/0026801 A1
(43) Pub. Date: Jan. 23, 2020

(54) MANAGING CONTENT SEARCHES IN COMPUTING ENVIRONMENTS

(71) Applicant: EMC IP HOLDING COMPANY LLC, Hopkinton, MA (US)

(72) Inventors: Rathi Babu, Bangalore (IN); Mainak Roy, Kolkata (IN)

(21) Appl. No.: 16/039,407

(22) Filed: Jul. 19, 2018

(51) Int. Cl. G06F 17/30; G06N 99/00; G06Q 30/02

(52) U.S. Cl. CPC G06F 17/30867; G06Q 30/0282; G06N 99/005; G06F 17/30377

(57) ABSTRACT

A method is used in managing content searches in computing environments. A repository receives a search phrase to retrieve content associated with the search phrase. A metadata analyzer module identifies updated content relevant to at least one first product associated with the retrieved content, where the retrieved content is replaced with the updated content to improve a satisfaction rate associated with the retrieved content. Based on the updated content, a machine learning system identifies second updated content to improve at least one second product satisfaction rate associated with at least one second product.

### BACKGROUND

### Technical Field

This application relates to managing content searches in computing environments.

### Description of Related Art

As the value and use of information continues to increase, businesses seek additional ways to provide information, and customers seek additional ways to obtain information. Providers of enterprise and client infrastructure solutions seek to provide customers with accurate information for their products and services across multiple lines of business (LOBs). One mode of providing information is through a search engine that stores relevant content in a repository, and serves up the content, such as help information, technical support, selectable buttons/icons, etc., when a customer enters a search phrase into the search engine. The search engine returns the content with a link to the content so that the customer may access the content, and a description of the content. The description of the content is referred to as the metadata description. In some cases, the results of the search engine search lead the customer to a web page that has selectable icons, such as buttons where a customer may begin to download software, etc. The description of the selectable icons may also be referred to as the metadata description.

### SUMMARY OF THE INVENTION

In accordance with one aspect of the invention is a method is used in managing content searches in computing environments. A repository receives a search phrase to retrieve content associated with the search phrase. A metadata analyzer module identifies updated content relevant to at least one first product associated with the retrieved content, where the retrieved content is replaced with the updated content to improve a satisfaction rate associated with the retrieved content. Based on the updated content, a machine learning system identifies second updated content to improve at least one second product satisfaction rate associated with at least one second product.

In accordance with one aspect of the invention is a system is used in managing content searches in computing environments. A repository receives a search phrase to retrieve content associated with the search phrase. A metadata analyzer module identifies updated content relevant to at least one first product associated with the retrieved content, where the retrieved content is replaced with the updated content to improve a satisfaction rate associated with the retrieved content. Based on the updated content, a machine learning system identifies second updated content to improve at least one second product satisfaction rate associated with at least one second product.

In accordance with another aspect of the invention, a computer program product comprising a computer readable medium is encoded with computer executable program code. The code enables execution across one or more processors for managing content searches in computing environments. A repository receives a search phrase to retrieve content associated with the search phrase. A metadata analyzer module identifies updated content relevant to at least one first product associated with the retrieved content, where the retrieved content is replaced with the updated content to improve a satisfaction rate associated with the retrieved content. Based on the updated content, a machine learning system identifies second updated content to improve at least one second product satisfaction rate associated with at least one second product.

### BRIEF DESCRIPTION OF THE DRAWINGS

Features and advantages of the present technique will become more apparent from the following detailed description of exemplary embodiments thereof taken in conjunction with the accompanying drawings in which:

FIG. 1 is a simplified illustration of a conventional search engine result, in accordance with an embodiment of the present disclosure.

FIG. 2 is a simplified illustration of a web result analyzer modules that produces content that dynamically adapts to search queries, in accordance with an embodiment of the present disclosure.

FIG. 3 is a simplified illustration of a metadata analyzer module, in accordance with an embodiment of the present disclosure.

FIG. 4 is a simplified illustration of a content updating module, in accordance with an embodiment of the present disclosure.

FIG. 5 is a simplified illustration of a CRO machine learning system, in accordance with an embodiment of the present disclosure.

FIG. 6 is a simplified illustration of an evaluation module, in accordance with an embodiment of the present disclosure.

FIG. 7 is a flow diagram illustrating processes that may be used in connection with techniques disclosed herein.

FIG. 8 is an example of an embodiment of an apparatus that may utilize the techniques described herein, in accordance with an embodiment of the present disclosure; and

FIG. 9 is an example of a method embodied on a computer readable storage medium that may utilize the techniques described herein, in accordance with an embodiment of the present disclosure.

### DETAILED DESCRIPTION OF EMBODIMENT(S)

Described below is a technique for use in managing content searches in computing environments, which technique may be used to provide, among other things, receiving, by a repository, a search phrase to retrieve content associated with the search phrase, identifying, by a metadata analyzer module, updated content relevant to at least one first product associated with the retrieved content, where the retrieved content is replaced with the updated content to improve a satisfaction rate associated with the retrieved content, and based on the updated content, identifying, by a machine learning system, second updated content to improve at least one second product satisfaction rate associated with at least one second product.

Ideally, the results of the search provide the customer with content relevant to their search phrase, and the customer selects the content (i.e., “clicks” on the results provided by the search engine). Businesses measure the rate at which the customer performs a desired action, such as selecting the content, filling out a form, etc. through a conversion rate. For example, a user entering a search phrase in a search engine is a “visitor”, but when that user clicks on a link in the search engine results, that user is converted to a “consumer of the information”. Thus, an example of a conversion rate may be when a user is converted from a “visitor” to a “consumer of the information”. Businesses often optimize their search engine results to increase the conversion rate. This optimization is referred to as Conversion Rate Optimization (CRO). Search engine results that decrease the conversion rate are known as “conversion killers”. Conversion killers may cost a company additional money. Customers who are unhappy with search engine results may pick up the phone to call a customer support center to resolve obtain the information the customer needs. These calls, known as “Request For Information” (RFI), require a call center to be staffed. Ultimately, the RFI calls add an additional, unnecessary, cost since the information is available to the customer. It is the conversion killers that contribute this additional cost since the information is available to the customer, but not presented to the customer through the search engine results and the content on the landing pages, in a manner that influences the customer to select the information. Conversely, producing content that dynamically adapts to the search queries to influence the visitor to select the content may reduce the RFI calls at cost centers, and reduce those costs.

Traditionally, businesses place great importance on making relevant information searchable by customers, and available to customers. To this effect, businesses employ search engine optimization (SEO) tactics to create a sustainable model that can be employed across LOBs. Generally, one goal is to provide customers with relevant information quickly and effectively. Typically, the goal of SEO is to ensure that relevant content appears higher in a search result so that the customer will select the content, and therefore, contribute to the conversation rate. However, SEO cannot assure that the customer will actually select the content that is presented in the search result. Usability studies have determined that an average person takes less than 10 seconds before the person selects from the content presented in the search results. As technology advances, that time frame continues to be drastically reduced. It is the customer's choice whether to select any of the links provided in the search engine search result, or to select an icon presented on a landing page. Thus, one goal of the techniques described herein is to increase the conversion rate of users/visitors who select from the search engine results to become a “consumer of the information” that is provided, for example, instead of contacting Tech Support, for example, at a call center to locate the same information that was provided by the search engine results.

When a customer enters a search phrase in a search engine, the search engine results may be relevant to the customer's query. However, if the content, more specifically, the metadata description, is not what the customer is looking for, the customer may determine that the results are not relevant to the search phrase. Even if a customer finds relevant content, and selects that content (i.e., “clicks’ on the search engine results), once on the landing page (i.e., the web page presented by the web browser when the customer selects a link in the web search results), the customer may be confused as to what to do next. For example, there may be icons (for example, “buttons”) on the landing page that are confusing to the customer. If the customer is presented, for example, with several options (i.e., buttons and/or icons) to download content, the customer must choose the correct button based on the text on the buttons. Dynamically adapting the content, for example, the text presented on buttons on the landing page to influence the customer's decision to select the content that's appropriate for the customer, can also increase CRO. Thus, another goal of the techniques described herein is to produce content that dynamically adapts to the search queries, and persuades the customer to select the content provided in the search engine results.

When the customer does not find content relevant to the entered search phrase (or doesn't know how to proceed once on the landing page), the customer may call Tech Support, for example, at a call center. Thus, one goal of the technique disclosed herein is to reduce the call volume at call centers when customers do not find relevant information through the search engine despite the relevant information being returned through the search engine results.

As described herein, in at least one embodiment of the current technique, a repository receives a search phrase, for example, entered by a user, to retrieve content associated with the search phrase. The retrieved content is presented as web results. A metadata analyzer module analyzes the web results to identify any conversion killers that may impact the CRO. The metadata analyzer module identifies updated content relevant to at least one first product associated with the retrieved content. The retrieved content is replaced with the updated content, by a content updating module, to improve the CRO associated with the retrieved content. Based on the updated content, a machine learning system identifies second updated content to improve at least one second product satisfaction rate associated with at least one second product. An evaluation module evaluates the CRO associated with content that was updated by the content updating module and/or the machine learning system.

Conventional technologies do not provide a technique to influence the customer's mind to select any of the content provided in the search engine search result. Conventional technologies do not provide metadata descriptions with content returned from search engines that are relevant to the search phrase entered into the search engine. Conventional technologies do not modify icons presented to users that influence the user to choose the information that is relevant to the user. Conventional technologies do not provide a machine learning system that identifies content changes that have increased conversion rates and why, identifies how these modifications relate to specific LOBs, and propagates those changes to other products and LOBs. Conventional technologies do not optimize the CRO without modifying the existing infrastructure or without adding an extra layer of hardware. Conventional technologies do not reduce the number of Request for Information (RFI) based calls to Tech Support.

By contrast, in at least some implementations in accordance with the current technique as described herein, a repository receives a search phrase to retrieve content associated with the search phrase. A metadata analyzer module identifies updated content relevant to at least one first product associated with the retrieved content, where the retrieved content is replaced with the updated content to improve a satisfaction rate associated with the retrieved content. Based on the updated content, a machine learning system identifies second updated content to improve at least one second product satisfaction rate associated with at least one second product.

Thus, the goal of the current technique is to provide a method and a system for managing content searches in computing environments and influence the customer's decision by providing the customer the information they are seeking.

In at least some implementations in accordance with the current technique described herein, the use of managing content searches in computing environments can provide one or more of the following advantages: providing metadata descriptions with content returned from search engines that are relevant to the search phrase entered into the search engine, improving the conversation rate by dynamically modifying the metadata description result of the search engine search without modifying the existing infrastructure of the support site or adding any extra layer of hardware, identifying metadata that decreases the conversion rate, modifying/generating influential metadata and icons to ensure that customers will consume the information provided by the results of the search engine search, providing a machine learning system that identifies content changes that have increased conversion rates and identifies why those changes have increased conversion rates, providing a machine learning system that identifies how these modifications relate to specific LOBs, and propagates those changes to other products and LOB, sand reducing the dependency to call Tech Support.

In contrast to conventional technologies, in at least some implementations in accordance with the current technique as described herein, a method manages content searches in computing environments. A repository receives a search phrase to retrieve content associated with the search phrase. A metadata analyzer module identifies updated content relevant to at least one first product associated with the retrieved content, where the retrieved content is replaced with the updated content to improve a satisfaction rate associated with the retrieved content. Based on the updated content, a machine learning system identifies second updated content to improve at least one second product satisfaction rate associated with at least one second product.

In an example embodiment of the current technique, an evaluation module evaluates at least one of an updated content satisfaction rate associated with the updated content, and at least one second product satisfaction rate.

In an example embodiment of the current technique, the updated content satisfaction rate associated with the updated content, and at least one second product satisfaction rate are evaluated by the metadata analyzer module.

In an example embodiment of the current technique, when the evaluation module evaluates at least one of the updated content satisfaction rate associated with the updated content, and at least one second product satisfaction rate, the evaluation module performs a comparison between the updated content and metadata associated with preferred content associated with at least one first product.

In an example embodiment of the current technique, when the metadata analyzer module identifies updated content relevant to at least one first product associated with the retrieved content, the metadata analyzer module filters the search phrase through a product group filter to identify at least one product group. The metadata analyzer module identifies a first product group comprising at least one first product, where at least one product group comprises the first product group.

In an example embodiment of the current technique, the metadata analyzer module identifies at least one third product, and identifies that the updated content is relevant to the third product based on an interdependency between at least one first product and the third product.

In an example embodiment of the current technique, when the metadata analyzer module identifies updated content relevant to at least one first product associated with the retrieved content, the metadata analyzer module compares metadata associated with the retrieved content with the search phrase. The metadata analyzer module determines, based on the comparison, that the metadata negatively impacts the satisfaction rate.

In an example embodiment of the current technique, when the metadata analyzer module identifies updated content relevant to at least one first product associated with the retrieved content, the metadata analyzer module identifies key search phrases associated with at least one product group, and identifies metadata associated with the key search phrases as preferred metadata.

In an example embodiment of the current technique, the metadata analyzer module compares metadata associated with key search phrase content returned in response to a search using at least one key search phrase with the preferred metadata, and determines whether to update the metadata associated with key search phrase content based on the comparison.

In an example embodiment of the current technique, when the machine learning system identifies second updated content to improve at least one second product satisfaction rate associated with at least one second product, the machine learning system identifies a strategy associated with the updated content that improved the satisfaction rate. The machine learning system applies the strategy to second content to determine how to transform the second content into the second updated content.

In an example embodiment of the current technique, when the machine learning system identifies second updated content to improve at least one second product satisfaction rate associated with at least one second product, the machine learning system identifies the updated content with an improved satisfaction rate. The machine learning system maps the updated content relevant to at least one first product to the second updated content relevant to at least one second product, and updates second content associated with at least one second product with the second updated content in at least one repository.

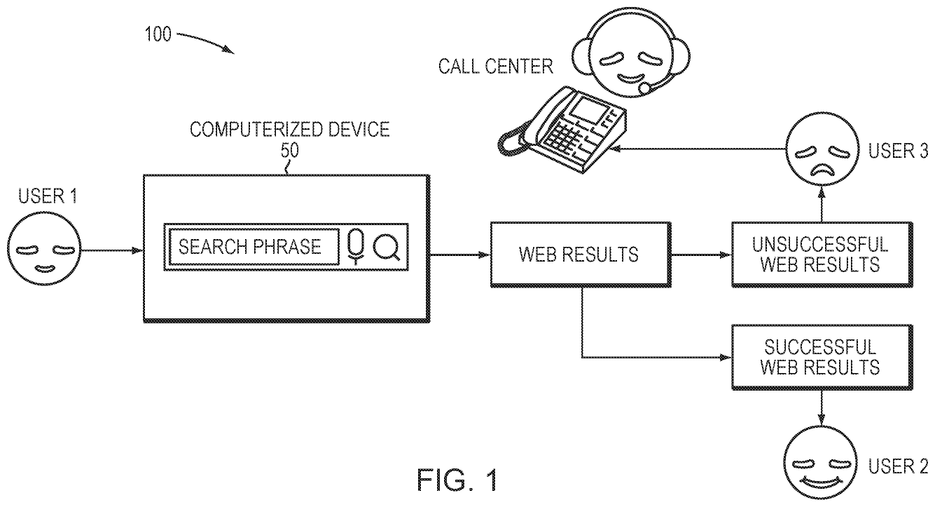

Referring now to FIG. 1, shown is a simplified illustration of a conventional search engine result, in accordance with an embodiment of the present disclosure. When a user (such as User 1) enters a search phrase into a search engine to retrieve content, for example, on a computerized device 50, the search engine retrieves content from repositories, and displays retrieved content in the form of web results 100. Ideally, the web results 100 contain retrieved content that is relevant to the user (i.e., relevant content), the user selects the content (i.e., the successful web results), and the user obtains the necessary information, as illustrated with User 2.

In some cases, the retrieved content is relevant to the user's search, but the user does not select the relevant content because the metadata (for example, the description that accompanies the search engine results, text on a button of a landing page, visual script, etc.) associated with the retrieved content (i.e., search engine results, landing pages, etc.) do not indicate to the user that the retrieved content is relevant to the user. Therefore, the retrieved content, although relevant content, results in unsuccessful web results. If the search engine returns relevant content, but the metadata descriptions do not indicate to the user that the content is relevant to the user's search phrase (and therefore, the user does not select the retrieved content as illustrated by User 3), this results in a low conversion rate. The conversion rate measures user satisfaction with the retrieved content and the accuracy of the information being displayed with respect to the search phrase. If the user does not locate the content the user requires (as illustrated by the unsuccessful web results), the user (i.e., User 3) may, for example, burden a call center, trying to locate the content the user requires.

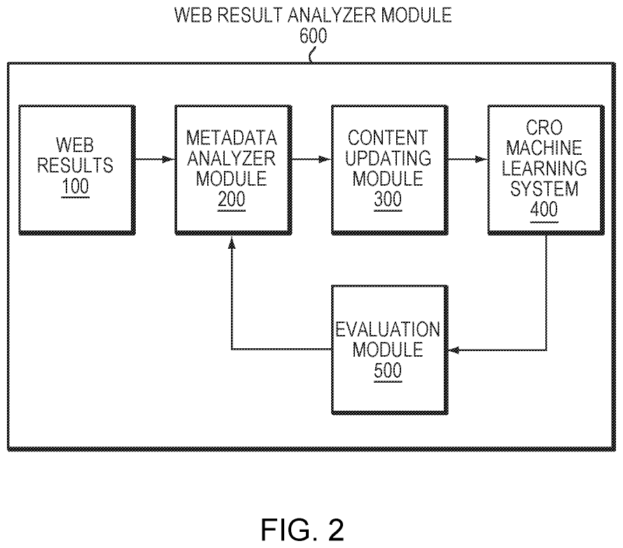

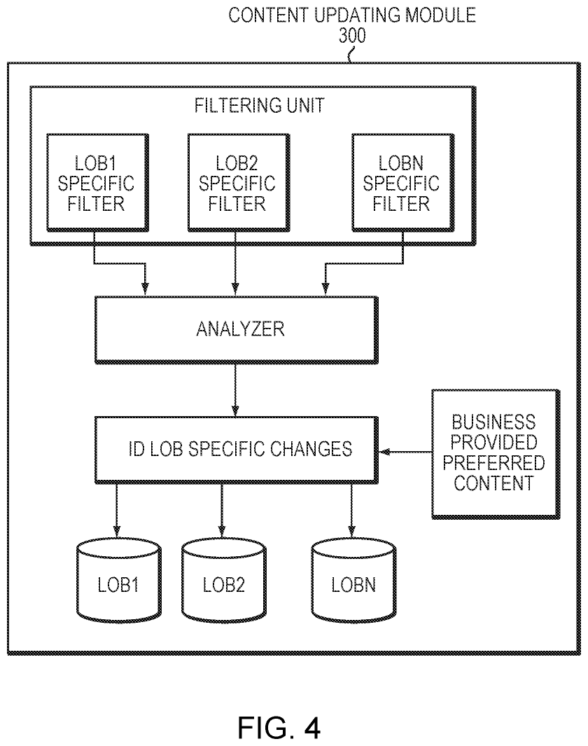

FIG. 2 is a simplified illustration of a web result analyzer modules that produces content that dynamically adapts to search queries, in accordance with an embodiment of the present disclosure. In an example embodiment, a web result analyzer module 600 is comprised of the web results 100, a metadata analyzer module 200, a content updating module 300, a machine learning system 400, and an evaluation module 500. In an example embodiment, the web result analyzer module 600 receives the web results 100, and transmits the web results 100 to the metadata analyzer module 200 for analysis. The metadata analyzer module 200 identifies content to be updated by the content updating module 300. For example, the metadata analyzer module 200 may identify that a particular metadata description, or a text description on a button/icon requires updating. The content updating module 300 identifies which products/LOBs are associated with the content to be updated as described in FIG. 4. The content updating module 300 also identifies other products/LOBs that may benefit from the updated content. The content updating module 300 updates the content, and provides the updated content to the CRO machine learning system 400. The CRO machine learning system 400 is trained using the updated content, and the CRO machine learning system 400 re-enforces the lessons learned to other products and other LOBs. In an example embodiment, the CRO machine learning system 400 identifies content to be updated in, for example, the other products and other LOBs, and replaces the content with the updated content. The evaluation module 500 evaluates the CRO of the updated content. In an example embodiment, the metadata analyzer module 200 also evaluates the CRO of both updated content and existing content to determine if either need to be updated again.

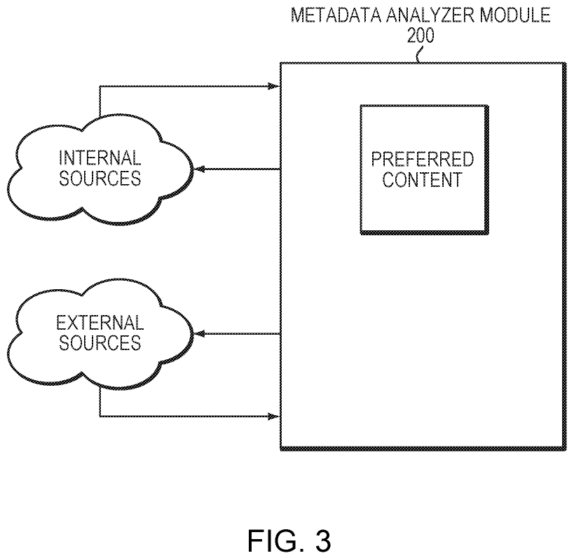

FIG. 3 is a simplified illustration of the metadata analyzer module 200, in accordance with an embodiment of the present disclosure. In embodiments disclosed herein, the metadata analyzer module 200 searches trends for key search phrases for specific lines of business (LOBs) from prior searches, for example, when the metadata analyzer module 200 verifies previously updated content, receiving input data from the evaluation module 500. The search trends are from previous keyword searches in the internal sources and/or the external sources. The metadata analyzer module 200 identifies preferred metadata for the LOB. The metadata analyzer module 200 compares the preferred metadata with the metadata associated with content that is returned as a result of the searches (both from internal and external sources) using the key search phrase. If the metadata analyzer module 200 identifies an incompatibility between the preferred metadata and the metadata associated with the returned content, the metadata analyzer module 200 identifies this content as content to be updated by the content updating module 300. In some embodiments, the metadata analyzer module 200 recommends how the content should be updated, for example, how the metadata description should be updated, how the text on a button/icon should be updated, etc.

In an example embodiment, the metadata analyzer module 200 verifies that the metadata associated with previously updated content is compatible with the preferred metadata. In some embodiments, the metadata analyzer module 200 identifies the preferred metadata based on search results associated with, for example, a particular product, a particular LOB, etc. The previously updated content may have been updated by the content updating module 300 and/or the CRO machine learning system 400.

FIG. 4 is a simplified illustration of the content updating module 300, in accordance with an embodiment of the present disclosure. The content updating module 300 identifies the updated content through a filtering unit that filters the search phrase through product group filters, specific to each line of business, to identify at least one product group. The product group identified by the filtering unit contains the first product. In an example embodiment, a second product is also identified, and updated content that is relevant to the second product is identified. The updated content relevant to the second product may be identified based on an interdependency between the first product and the second product. The first and second product may be in the same product group, or may be in different product groups or different LOBs. In other words, the metadata analyzer module 200 identifies content that requires updating. The content updating modules 300 identifies products and/or LOBs that are associated with the content. For example, the metadata analyzer module 200 may identify that content associated with the first product requires updating. The filtering unit may identify that content associated with the second product (in the same or a different LOB) also requires updating. The second product may be identified based on an interdependency between the first product and/or the second product.

In an example embodiment, an analyzer assists in determining specific LOBs in which to update content. In an example embodiment, the analyzer first analyzes the returned URL from the business' internal repository. The returned URL provides information about a product described on the page associated with the returned URL. The analyzer then analyzes any associated “Call To Action” (CTA), since based on the information mapping, the CTAs generally provide product related information. For example, the CTA may be a button that a user selects to download, for example, software. The CTA may have associated text such as what version and/or product the downloadable software references. Thus, a user faced with a landing page comprising several CTAs, each with different descriptions, may be influenced to select the appropriate CTA based on a relevant description (i.e., metadata description) associated with the CTA.

In an example embodiment, preferred content is identified. In some embodiments, the preferred content may be identified by the metadata analyzer module 200. This preferred content may be obtained from, for example, a LOB related database, or any database (associated with the business, of indexed web pages. Preferred content is a more suitable description for the metadata description. In an example embodiment, preferred content is metadata that has previously resulted in a positive CRO. Preferred content may be obtained from the LOB database, a database associated with the business, previously updated content, etc.

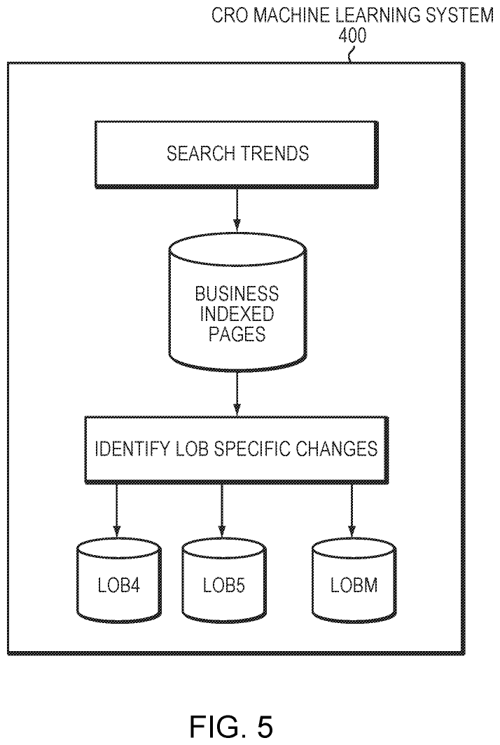

The content updating module 300 identifies products relevant to the search phrase, and provides updated content relevant to those identified products. The content updating module 300 updates the retrieved content with relevant metadata to create the updated content. The updated content is updated within the databases specific to each LOB identified. Information associated with the updated content is fed as input into the CRO machine learning system 400 (FIG. 5, further explained below).

FIG. 5 is a simplified illustration of the CRO machine learning system 400, in accordance with an embodiment of the present disclosure. The CRO machine learning system 400 utilizes the information associated with the updated content, such as search engine search trends and updated content from indexed pages for the business, that has had a positive impact on CRO, to identify other product lines in the LOB, and in other LOBs where the conversion rates may be improved by applying the same strategies that were determined for the updated content. The CRO machine learning system 400 also identifies additional updated content for other product lines in the line of business, and in other lines of business, and then propagates these changes across these other product lines. Thus, the CRO machine learning system 400 identifies updated content/metadata that has improved the conversion rate for particular products/LOBs, identifies how this strategy/information applies to other products/LOBs, and propagates these changes to other products/LOBs in a manner that's relevant to those other products/LOBs. The CRO machine learning system 400 continues to learn which changes improve the conversion rate, and continues to propagate these changes throughout the LOBs.

The CRO machine learning system 400 re-enforces the conversion rate optimization improvements determined for the updated content, for example, Product 1 from LOB1 to other products in LOB1 and other products in other LOBs. As illustrated in FIG. 4, LOB1, LOB2, and LOBN were updated by the content updating module 300. As illustrated in FIG. 5, LOB4, LOBS, and LOBM are LOBs identified by the CRO machine learning system 400 as containing content that may benefit from updated content. In an example embodiment, LOB4, for example, may be a different LOB than LOB1, or it may be an iterative update of LOB1, as the CRO machine learning system 400 continuously updates and improves the content associated with the LOBs. The CRO machine learning system 400 learns, continues to learn, and propagates/re-enforces those lessons learned to other products and other LOBs.

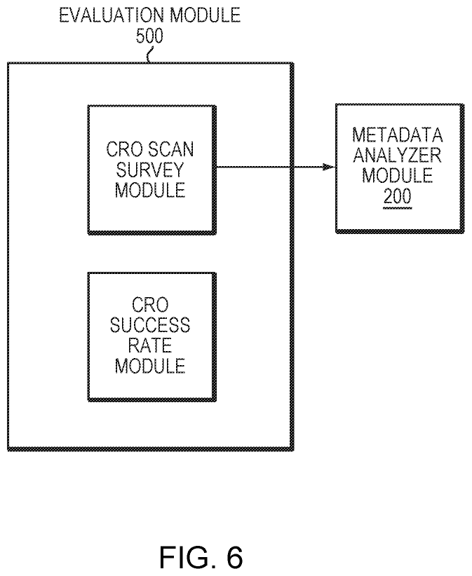

FIG. 6 is a simplified illustration of the evaluation module 500, in accordance with an embodiment of the present disclosure. The CRO Scan Survey module identifies content that has been updated by either the content updating module 300, or the CRO machine learning system 400. This data is utilized by the metadata analyzer module 200. The metadata analyzer module 200 verifies that the metadata associated with previously updated content is compatible with the preferred metadata, and if necessary identifies content that requires updating (meaning, in some cases, re-updating) by the content updating module 300. The CRO Success Rate module identifies the number of times the updated content is analyzed by the metadata analyzer module 200 during subsequent review cycles.

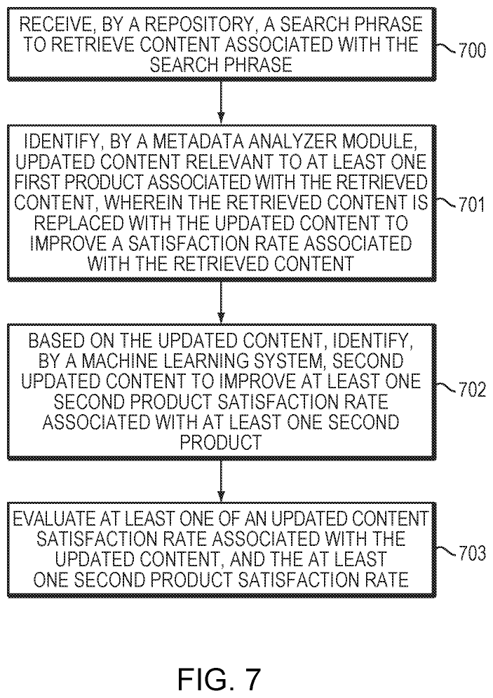

Referring to FIG. 7, shown is a more detailed flow diagram illustrating managing content searches in computing environments. With reference also to FIGS. 1-6, a repository receives a search phrase to retrieve content associated with the search phrase (Step 700). For example, a user enters a search phrase into a search engine, and the search engine produces the retrieved content.

In an example embodiment, the metadata analyzer module 200 identifies updated content relevant to at least one first product associated with the retrieved content, where the retrieved content is replaced with the updated content to improve a satisfaction rate associated with the retrieved content (Step 701). In an example embodiment, the metadata analyzer module 200 filters the search phrase through a product group filter to identify at least one product group. The metadata analyzer module 200 identifies a first product group comprising at least one first product, where at least one product group comprises the first product group. The metadata analyzer module 200 identifies at least one third product, and identifies that the updated content is relevant to the third product based on an interdependency between at least one first product and the third product. In other words, the metadata analyzer module 200 filters the search phrase through the product group filter to identify any products for which that search phrase is relevant. The metadata analyzer module 200 identifies additional products that may benefit from the updated content based on an interdependency between the additional products identified, and the set of products for which the search phrase is relevant.

In an example embodiment, the metadata analyzer module 200 identifies the most searched keyword phrases, and identifies CTAs that are returned when those keyword phrase are searched. The CTAs are identified from different web searches, for example, both external and internal web sources. The metadata analyzer module 200 then identifies the most frequently reported scenarios. The metadata analyzer module 200 applies the most frequently reported scenarios to a repository of indexed web content to identify the CTAs and indexed web pages that would benefit from similar updated content. In this manner, the metadata analyzer module 200 periodically updates the metadata associated with the CTAs and indexed web pages. The content updating module 300 then updates the identified CTAs and index web pages, for example, in LOB specific repositories.

In an example embodiment, the metadata analyzer module 200 compares metadata associated with the retrieved content with the search phrase, and determines, based on the comparison, that the metadata negatively impacts the satisfaction rate. In an example embodiment, metadata that negatively impacts the satisfaction rate is referred to as “conversion killers”. In other words, search results that do not motivate the user to select the search result that is relevant to the user's search phrase reduce the conversion rate, and are therefore, “conversion killers”. Examples of “conversion killers” include:
Generic calls to action (CTA) texts (for example, the text that accompanies a “Download Software” button on a landing page)
Unreciprocated Texts without actions (for example, generic terms used in graphical user interface (GUI) items, action buttons, call to text buttons, etc. which don't provide the task details which can be performed by this action)
Corporate jargons leading to confusion
Including too many fields in CTA
Failure to add personalize texts in the Meta description of the product/landing page/indexing pages
Excessive usage of passive voice
Generic headings without having product identifications
Absence of strong Key Phases
Multiple CTAs redirecting the same actions that confuse the users
Images with misleading/too many texts
Landing page indexing without proper identification of the product

In an example embodiment, the CTA are mapped in real-time by the content updating module 300, based on the search phrase entered into the search engine by the user. Generally,

CTAs are constant, and pre-defined for particular web pages, and contain generic terms, such as “Download”, “Install”, “Run”, “Upgrade”, etc. Generic terms may not motivate a user to select a particular CTA, especially, for example, if the user is faced with a landing page with more than one CTA, and if it is not clear to the user which CTA is relevant to the user's search query. In contrast, a CTA that is customized based on the user's search phrase adds value to the product the user has searched for, since the customized CTA may better describe the benefit of the user selecting a particular CTA.

In an example embodiment, metadata analyzer module 200 dynamically identifies the CTAs that need to be updated through the LOB specific filters as illustrated in FIG. 4. In an example embodiment, the LOB specific filters comprise multiple CTAs specific to that product, where the CTAs describe, for example, the functionality, usability, advantage, importance, etc. of that particular CTA. By updating the CTAs (for example, by the metadata analyzer module 200, the content updating module 300, and/or the CRO machine learning system 400), the web result analyzer module 600 is able to modify the CTAs quickly to influence the user's decision to select a particular CTA that is relevant to the user's query. In other words, the metadata analyzer module 200 identifies, based on the past search queries, the more suitable CTA description associated with that search query for a particular product, and through the content updating module 300, the web result analyzer module 600 adopts that change dynamically.

In an example embodiment, the metadata analyzer module 200 identifies key search phrases associated with at least one product group, and identifies metadata associated with the key search phrases as preferred metadata. In an example embodiment, the metadata analyzer module 200 compares metadata associated with key search phrase content returned in response to a search using at least one key search phrase with the preferred metadata, and determines whether to update the metadata associated with key search phrase content based on the comparison. It should be noted that the terms preferred metadata and preferred content may be used interchangeably.

In an example embodiment, based on the updated content, the CRO machine learning system 400 identifies second updated content to improve at least one second product satisfaction rate associated with at least one second product (Step 702). In an example embodiment, the CRO machine learning system 400 learns (and re-learns) usage patterns based on user web searches, to both propagate the “lessons learned” to update the content associated with other products, as well as to continuously learn and update previously updated content. Thus, the CRO machine learning system 400 identifies CRO goals for specific LOBs, since these are different for different LOBs. The CRO machine learning system 400 determines updated content for specific LOBs to guide businesses to produce information that influences the users searching for that information to choose that information. Thus, the CRO for these businesses is improved without modifying the existing infrastructure of the support site, nor adding any extra layers of hardware.

In an example embodiment, the CRO machine learning system 400 identifies updated products according to the following formula:

$${\sum }_{i = 1}^{m} \frac{p ( n )}{p ( A \vert B \vert C )}$$

p(n)=A call to text, coming from the user.

(A|B|C)=Summation of call to text of any product which is already in the database.

In an example embodiment, the CRO machine learning system 400 identifies a strategy associated with the updated content that improved the satisfaction rate, and applies the strategy to second content to determine how to transform the second content into the second updated content.

In an example embodiment, the CRO machine learning system 400 identifies the updated content with an improved satisfaction rate, and maps the updated content relevant to at least one first product to the second updated content relevant to at least one second product. For example, the CRO machine learning system 400 identifies metadata that has had a positive impact on the conversion rate. In response, the CRO machine learning system 400 identifies the scenarios/images/texts/etc. that resulted in a higher incidents of user selection (i.e., a user selected or “clicked on” that content). In an example embodiment, the CRO machine learning system 400 then maps that information to at least one second product. The CRO machine learning system 400 then updates second content associated with at least one second product with the second updated content in at least one repository, for example, a database specific to the second product, such as LOB1 as illustrated in FIG. 4.

In an example embodiment, the evaluation module 500 evaluates at least one of an updated content satisfaction rate associated with the updated content, and at least one second product satisfaction rate (Step 703). For example, the evaluation module 500 compares the content satisfaction rate (i.e., the CRO) of two products, to determine if either CRO may be improved. In an example embodiment, the evaluation module 500 examines existing content with respect to the product and version of that product to improve the accuracy of the content based on the knowledge of key search phrases provided by the user. In an example embodiment, the evaluation module 500 performs a comparison between the updated content and metadata associated with preferred content associated with at least one first product.

In an example embodiment, the evaluation module 500 is comprised of a scan survey module, and a CRO Success Rate module.

In an example embodiment, the CRO Scan Survey module identifies content that has been updated by either the content updating module, or the CRO machine learning system. In an example embodiment, the CRO Scan Survey module uses the following formula to identify the modified content:

$$P ( A \vert B ) = P ( A \vert B \vert C \vert D \vert … \vert n ) \frac{p ( A )}{P ( LOB )}$$

p(A)=New CRO Content

P(LOB)=Content with respective to LOB

P(A|B|C|D|. . . |n)=Modified CRO Content

In an example embodiment, the CRO success rate module identifies the number of times the updated content is analyzed by the metadata analyzer module during subsequent review cycles. In an example embodiment, the CRO success rate module uses the following formula:

$$P ( A \vert B \vert C \vert … … . \vert n ) = \frac{p ( A ⋂ B … … . ⋂ n )}{P ( Product / Version )}$$

p(A∩B . . . ∩n)=Different CTAs

P(Product/Version)=Respective to Products or Versions

In an example embodiment, the CRO success rate modules identifies the number of times the modified content, for example, modified CTAs are identified by the metadata analyzer module 200, for example, as preferred content, during subsequent search queries. The number of times the modified CTAs are identified by the metadata analyzer module 200 determines the success for a particular modified CTA. The modified CTAs may now be categorized against a particular product, or a specific version of a particular product. Thus, the identified preferred content may be propagated to other products and/or versions, through the metadata analyzer module 200 and/or the CRO machine learning system 400. In an example embodiment, the CRO machine learning system 400 examines existing content with respect to product and version to improve the quality and accuracy of the content based on the key search phrases (tracked by the metadata analyzer module 200) that users enter into search engines for particular products and/or versions.

In an example embodiment, the updated content satisfaction rate associated with the updated content, and at least one second product satisfaction rate are evaluated by the metadata analyzer module 200. In other words, once the content has been identified for update through the CRO machine learning system 400, the updated content satisfaction rate may be tracked through the metadata analyzer module 200.

There are several advantages to embodiments disclosed herein. For example, the method provides metadata descriptions with content returned from search engines that are relevant to the search phrase entered into the search engine. The method improves the conversation rate by dynamically modifying/generating influential metadata descriptions and icons to ensure that customers will consume the information provided by the results of the search engine search. The method improves the conversation rate by dynamically modifying the metadata description result of the search engine search without modifying the existing infrastructure of the support site or adding any extra layer of hardware. The method identifies metadata that decreases the conversion rate. The method provides a machine learning system that identifies content changes that have increased conversion rates and why those content changes have increased the conversion rate. The method provides a machine learning system that identifies how these modifications relate to specific LOBs, and propagates those changes to other products and LOB. The method reduces the dependency to call Tech Support when the information is already provided by the search engine results.

The methods and apparatus of this invention may take the form, at least partially, of program code (i.e., instructions) embodied in tangible non-transitory media, such as floppy diskettes, CD-ROMs, hard drives, random access or read only-memory, or any other machine-readable storage medium.

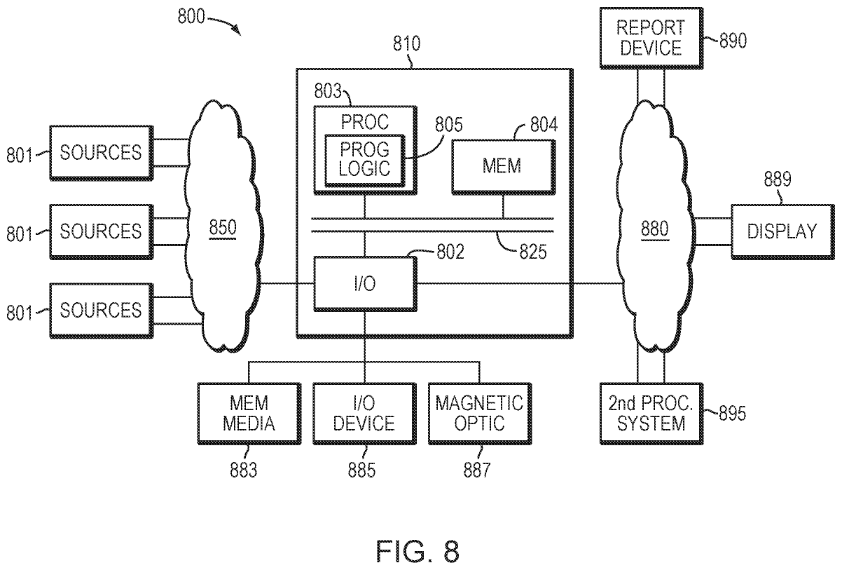

FIG. 8 is a block diagram illustrating an apparatus, such as a computer 810 in a network 800, which may utilize the techniques described herein according to an example embodiment of the present invention. The computer 810 may include one or more I/O ports 802, a processor 803, and memory 804, all of which may be connected by an interconnect 825, such as a bus. Processor 803 may include program logic 805. The I/O port 802 may provide connectivity to memory media 883, I/O devices 885, and drives 887, such as magnetic or optical drives. When the program code is loaded into memory 804 and executed by the computer 810, the machine becomes an apparatus for practicing the invention. When implemented on one or more general-purpose processors 803, the program code combines with such a processor to provide a unique apparatus that operates analogously to specific logic circuits. As such, a general purpose digital machine can be transformed into a special purpose digital machine.

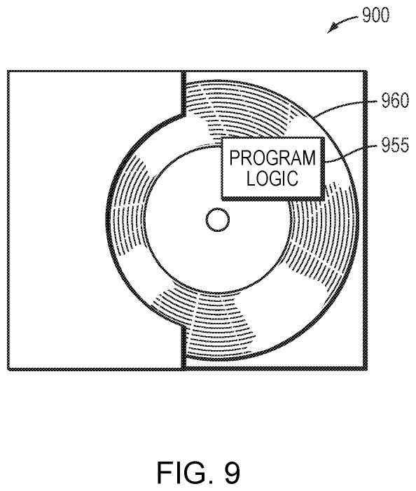

FIG. 9 is a block diagram illustrating a method embodied on a computer readable storage medium 960 that may utilize the techniques described herein according to an example embodiment of the present invention. FIG. 9 shows Program Logic 955 embodied on a computer-readable medium 960 as shown, and wherein the Logic is encoded in computer-executable code configured for carrying out the methods of this invention and thereby forming a Computer Program Product 900. Program Logic 955 may be the same logic 805 on memory 804 loaded on processor 803 in FIG. 8. The program logic may be embodied in software modules, as modules, as hardware modules, or on virtual machines.

The logic for carrying out the method may be embodied as part of the aforementioned system, which is useful for carrying out a method described with reference to embodiments shown in, for example, FIGS. 1-9. For purposes of illustrating the present invention, the invention is described as embodied in a specific configuration and using special logical arrangements, but one skilled in the art will appreciate that the device is not limited to the specific configuration but rather only by the claims included with this specification.

Although the foregoing invention has been described in some detail for purposes of clarity of understanding, it will be apparent that certain changes and modifications may be practiced within the scope of the appended claims. Accordingly, the present implementations are to be considered as illustrative and not restrictive, and the invention is not to be limited to the details given herein, but may be modified within the scope and equivalents of the appended claims.

It should again be emphasized that the technique implementations described above are provided by way of illustration, and should not be construed as limiting the present invention to any specific embodiment or group of embodiments. For example, the invention can be implemented in other types of systems, using different arrangements of processing devices and processing operations. Also, message formats and communication protocols utilized may be varied in alternative embodiments. Moreover, various simplifying assumptions made above in the course of describing the illustrative embodiments should also be viewed as exemplary rather than as requirements or limitations of the invention. Numerous alternative embodiments within the scope of the appended claims will be readily apparent to those skilled in the art.

Furthermore, as will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

The flowchart and block diagrams in the FIGs illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been disclosed in connection with preferred embodiments shown and described in detail, their modifications and improvements thereon will become readily apparent to those skilled in the art. Accordingly, the spirit and scope of the present invention should be limited only by the following claims.

What is claimed is:

1. A method of managing content searches in computing environments, the method comprising:
receiving, by a repository, a search phrase to retrieve content associated with the search phrase;
identifying, by a metadata analyzer module, updated content relevant to at least one first product associated with the retrieved content, wherein the retrieved content is replaced with the updated content to improve a satisfaction rate associated with the retrieved content; and
based on the updated content, identifying, by a machine learning system, second updated content to improve at least one second product satisfaction rate associated with at least one second product.

2. The method of claim 1, further comprising:
evaluating at least one of an updated content satisfaction rate associated with the updated content, and the at least one second product satisfaction rate.

3. The method of claim 2, wherein the updated content satisfaction rate associated with the updated content, and the at least one second product satisfaction rate are evaluated by the metadata analyzer module.

4. The method of claim 2, wherein evaluating the at least one of the updated content satisfaction rate associated with the updated content, and the at least one second product satisfaction rate comprises:
performing a comparison between the updated content and metadata associated with preferred content associated with the at least one first product.

5. The method of claim 1, wherein identifying, by the metadata analyzer module, updated content relevant to the at least one first product associated with the retrieved content comprises:
filtering the search phrase through a product group filter to identify at least one product group; and
identifying a first product group comprising the at least one first product, wherein the at least one product group comprises the first product group.

6. The method of claim 5, further comprising:
identifying at least one third product; and
identifying that the updated content is relevant to the third product based on an interdependency between the at least one first product and the third product.

7. The method of claim 1, wherein identifying, by the metadata analyzer module, updated content relevant to the at least one first product associated with the retrieved content comprises:
comparing metadata associated with the retrieved content with the search phrase; and
determining, based on the comparison, that the metadata negatively impacts the satisfaction rate.

8. The method of claim 1, wherein identifying, by the metadata analyzer module, updated content relevant to the at least one first product associated with the retrieved content comprises:
identifying, by the metadata analyzer module, key search phrases associated with at least one product group; and
identifying metadata associated with the key search phrases as preferred metadata.

9. The method of claim 8, further comprising:
comparing metadata associated with key search phrase content returned in response to a search using at least one key search phrase with the preferred metadata; and
determining whether to update the metadata associated with key search phrase content based on the comparison.

10. The method of claim 1, wherein identifying, by the machine learning system, second updated content to improve the at least one second product satisfaction rate associated with the at least one second product comprises:
identifying, by the machine learning system, a strategy associated with the updated content that improved the satisfaction rate; and
applying, by the machine learning system, the strategy to second content to determine how to transform the second content into the second updated content.

11. The method of claim 1, wherein identifying, by the machine learning system, second updated content to improve the at least one second product satisfaction rate associated with the at least one second product comprises:
identifying, by the machine learning system, the updated content with an improved satisfaction rate;
mapping the updated content relevant to the at least one first product to the second updated content relevant to the at least one second product; and
updating second content associated with the at least one second product with the second updated content in at least one repository.

12. A system for use in managing content searches in computing environments, the system comprising a processor configured to:
receive, by a repository, a search phrase to retrieve content associated with the search phrase;
identify, by a metadata analyzer module, updated content relevant to at least one first product associated with the retrieved content, wherein the retrieved content is replaced with the updated content to improve a satisfaction rate associated with the retrieved content; and
based on the updated content, identify, by a machine learning system, second updated content to improve at least one second product satisfaction rate associated with at least one second product.

13. The system of claim 12, further configured to:
evaluate at least one of an updated content satisfaction rate associated with the updated content, and the at least one second product satisfaction rate.

14. The system of claim 12, wherein the processor configured to identify, by the metadata analyzer module, updated content relevant to the at least one first product associated with the retrieved content is further configured to:
filter the search phrase through a product group filter to identify at least one product group; and
identify a first product group comprising the at least one first product, wherein the at least one product group comprises the first product group.

15. The system of claim 14, further configured to:
identify at least one third product; and
identify that the updated content is relevant to the third product based on an interdependency between the at least one first product and the third product.

16. The system of claim 12, wherein the processor configured to identify, by the metadata analyzer module, updated content relevant to the at least one first product associated with the retrieved content is further configured to:
identify, by the metadata analyzer module, key search phrases associated with at least one product group; and
identify metadata associated with the key search phrases as preferred metadata.

17. The system of claim 16, further configured to:
compare metadata associated with key search phrase content returned in response to a search using at least one key search phrase with the preferred metadata; and
determine whether to update the metadata associated with key search phrase content based on the comparison.

18. The system of claim 12, wherein the processor configured to identify, by the machine learning system, second updated content to improve the at least one second product satisfaction rate associated with the at least one second product is further configured to:
identify, by the machine learning system, a strategy associated with the updated content that improved the satisfaction rate; and
apply, by the machine learning system, the strategy to second content to determine how to transform the second content into the second updated content.

19. The system of claim 12, wherein the processor configured to identify, by the machine learning system, second updated content to improve the at least one second product satisfaction rate associated with the at least one second product is further configured to:
identify, by the machine learning system, the updated content with an improved satisfaction rate;
map the updated content relevant to the at least one first product to the second updated content relevant to the at least one second product; and
update second content associated with the at least one second product with the second updated content in at least one repository.

20. A computer program product for managing content searches in computing environments, the computer program product comprising:
a computer readable storage medium having computer executable program code embodied therewith, the program code executable by a computer processor to:
receive, by a repository, a search phrase to retrieve content associated with the search phrase;
identify, by a metadata analyzer module, updated content relevant to at least one first product associated with the retrieved content, wherein the retrieved content is replaced with the updated content to improve a satisfaction rate associated with the retrieved content; and
based on the updated content, identify, by a machine learning system, second updated content to improve at least one second product satisfaction rate associated with at least one second product.
